(19) United States
(12) Patent Application Publication
(10) Pub. No.: US 2024/0419441 A1
(43) Pub. Date: Dec. 19, 2024

(54) WORKFLOW DESIGN AND IMPLEMENTATION USING FLOWCHARTS

(71) Applicant: Cloudian Holdings, Inc., San Mateo, CA (US)

(72) Inventors: James Gibbs, San Mateo, CA (US); Neil Berrington, San Mateo, CA (US); Bharatendra Boddu, San Mateo, CA (US)

(21) Appl. No.: 18/742,498

(22) Filed: Jun. 13, 2024

Related U.S. Application Data
(60) Provisional application No. 63/507,820, filed on Jun. 13, 2023.

(51) Int. Cl. G06F 8/75; G06F 21/62

(52) U.S. Cl. CPC G06F 8/75; G06F 21/62

(57) ABSTRACT

Source code can be converted into workflows and visualized. A flowchart definition language may be utilized for generating flowcharts representing the source code. Conversely, the visualization can be converted into source code using different languages.

### CROSS REFERENCE

This application is based on and claims the benefit of priority to U.S. Provisional Patent Application No. 63/507,820, filed on Jun. 13, 2023, which is herein incorporated by reference in its entirety.

### TECHNICAL FIELD OF THE INVENTION

The present invention relates to a system or method for a flowchart definition language to define workflows separate from source code.

### BACKGROUND

Computer programs are becoming ever more complex, along with the source code that implements them. As projects grow in size, it is common for the in-depth understanding of the source code to be spread out or held by only a few engineers. Established projects may use older programming languages, language versions, or tools that are less well-known by contemporary programmers. The problem may be compounded if/when subject matter experts leave a team. These factors can make it expensive and inefficient to modify/enhance existing code for fear of inadvertently changing its behavior and introducing bugs.

### BRIEF SUMMARY

The present invention relates to a method, system or apparatus and/or computer program product for a flowchart definition language to define workflows separate from source code. Source code can be visualized into workflows. A flowchart definition language may be utilized for generating flowcharts representing the source code. The visualization can be converted into source code using different languages.

### BRIEF DESCRIPTION OF THE DRAWINGS

The figures illustrate principles of the invention according to specific embodiments. Thus, it is also possible to implement the invention in other embodiments, so that these figures are only to be construed as examples. Moreover, in the figures, like reference numerals designate corresponding modules or items throughout the different drawings.

FIG. 1 illustrates an example network system.

FIG. 2 illustrates an example flowchart preprocessor node.

FIG. 3 illustrates an example flowchart for Access Control List (ACL).

FIG. 4 illustrates an example flowchart for ACL bucket.

FIG. 5 illustrates an example flowchart for ACL object.

FIG. 6 illustrates an example flowchart for a copy operation.

FIG. 7 illustrates an example flowchart for object copy.

FIG. 8 illustrates an example flowchart for bucket creation.

FIG. 9 illustrates an example flowchart for a no object operation.

FIG. 10 illustrates an example flowchart for S3 permissions.

FIG. 11 illustrates an example flowchart for a main operation in S3 permissions.

FIG. 12 illustrates an example flowchart for uploading part of a copy.

### DETAILED DESCRIPTION OF THE DRAWINGS AND PREFERRED EMBODIMENTS

By way of introduction, the disclosed embodiments relate to systems and methods for a flowchart definition language to define workflows separate from source code. Source code can be visualized into workflows. A flowchart definition language may be utilized for generating flowcharts representing the source code. The visualization can be converted into source code using different languages.

Many computer processes can be described as workflows. There may be multiple workflows used in combination when handling end-to-end operations. For example, handling an Application Programming Interface (API) call involves workflows for requesting authentication and authorization, API request validation, API request handling, service or network load balancing and persistent storage, in just one example. If the independent workflows are all implemented within the same source code, it may be difficult to visualize the behavior of each workflow and the interactions between them. Even in well-designed code, in which individual workflows are separated within the source code, workflows may include complex internal logic and multiple decision branches that can be difficult to understand.

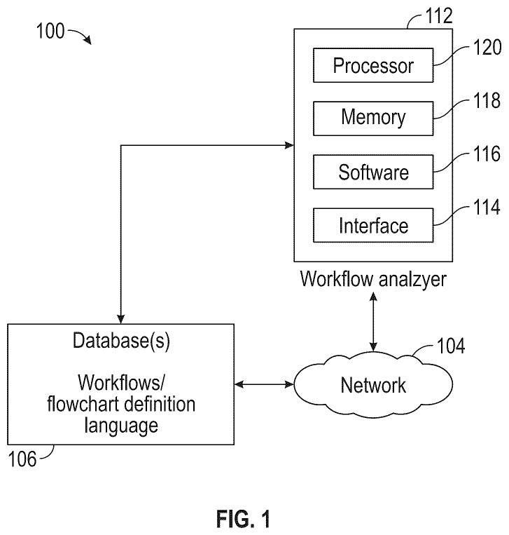

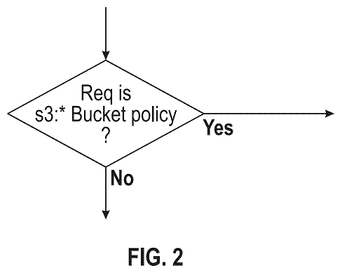

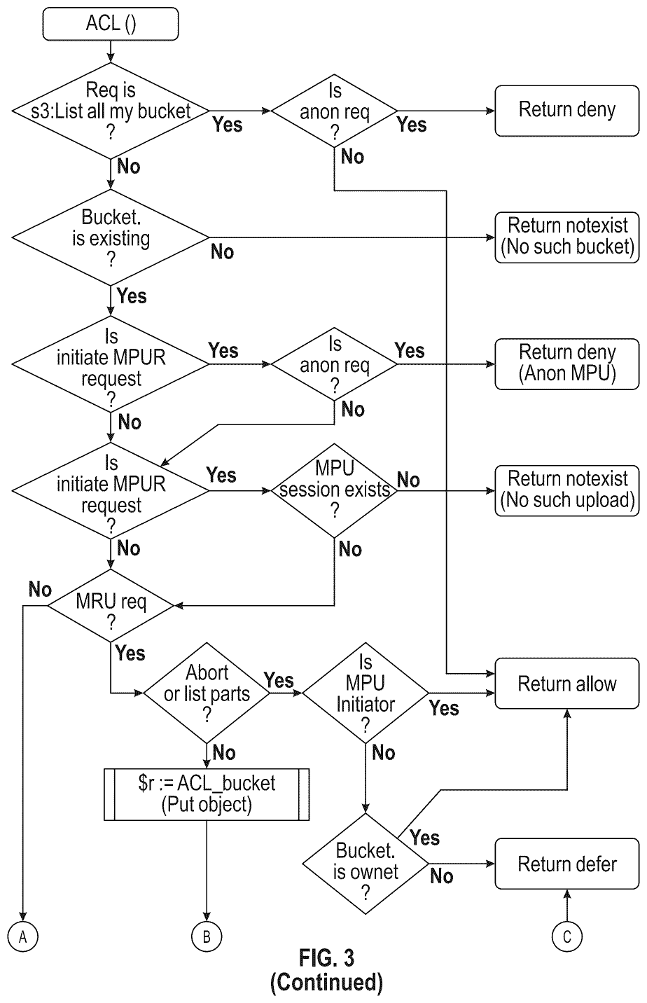

There may be source code design practices such as modularization of independent workflows, enforcement of strict APIs between those modules and engineering processes such as test driven development that ensure that APIs are defined and independently testable before they are implemented. Such separation can be more strictly enforced through the use of a microservices architecture, where each module runs in a separate service, though such an architecture may not be applicable (e.g., in highly-optimized, performance critical code where the cost of an internal REST API call is prohibitive). This approach may improve the source code understanding, but may be difficult to enforce and maintain in the long term. For example, the meaning of an API can be circumvented or logic outside the correct source code module can be implemented. Relying on extensive source code comments, along with hand-in-hand with tools to convert the comments into source code documentation that can be navigated via a web browser, may be inefficient or inaccurate. To understand complex internal logic of individual workflows, the following example flowchart definition language can be utilized for generating workflows for visualization. The following example network system (FIG. 1) may be used to implement the generated workflows shown in FIGS. 2-12.

### Example Network System

FIG. 1 illustrates an example network system 100. The system 100 may utilize a flowchart definition language to generate workflows that can be visualized. The visualized workflows represent the source code. In particular, the workflow analyzer 112 may generate and define workflows for source code in a distributed storage system. The distributed storage system may include one or more databases 106 over a network 104. In other embodiments, the database(s) 106 may also be connected directly with the workflow analyzer 112. In one embodiment, the workflow analyzer 112 may be software that runs on a computing device as shown in FIG. 1. The workflow analyzer 112 may define and implement and generate visualization of the workflows shown in FIGS. 2-12.

The workflow analyzer 112 may include one or more components for performing flowchart definition language analyses and visual workflow generation. The workflow analyzer may include a processor 120, a memory 118, software 116, and/or a user interface 114. In alternative embodiments, the workflow analyzer 112 may include multiple devices to provide different functions and it may or may not include all of the user interface 114, the software 116, the memory 118, and/or the processor 120. In some embodiments, the workflow analyzer 112 may be implemented in software on a centralized or distributed network system.

The interface 114 may be a user input device or a display. The user interface 114 may include a keyboard, keypad or a cursor control device, such as a mouse, or a joystick, touch screen display, remote control or any other device operative to allow a user or administrator to interact with the workflow analyzer 112. The user interface 114 may communicate with any of the systems in the network 104, including the workflow analyzer 112 or any other components in a distributed network system. The user interface 114 may include a user interface configured to allow a user and/or an administrator to interact with any of the components of the workflow analyzer 112 for providing access and functionality for visual workflows as in FIGS. 2-12. The user interface 114 may include a display coupled with the processor 120 and configured to display an output from the processor 120. The display (not shown) may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing data.

The processor 120 in the workflow analyzer 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program (i.e. software 116), such as code generated manually (i.e., programmed). The software 116 may include a process for consistent hashing and/or hash token selection balancing.

The processor 120 may be coupled with the memory 118, or the memory 118 may be a separate component. In some embodiments, there may not be a memory 118 as part of the workflow analyzer 112, which utilizes data from one or more separate database(s) 106, including the source code, the flowchart definition language, and the generated workflows. In some embodiments, the software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded tracking data, or an analysis of the data. Examples include a hard drive, compact disc (“CD”), digital video disc (“DVD”), memory card, memory stick, floppy disc, universal serial bus (“USB”) memory device, or any other device operative to store data. The memory 118 is operable to store instructions executable by the processor 120.

The functions, acts or tasks illustrated in the figures and/or described herein may be performed by the programmed processor executing the instructions stored in the software 116 or the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116.

The present disclosure contemplates a computer-readable medium that includes instructions or receives and executes instructions responsive to a propagated signal, so that a device connected to a network can communicate voice, video, audio, images or any other data over a network. The user interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

Any of the components in the system 100 may be coupled with one another through a (computer) network, including but not limited to the network 104. In some embodiments, the system may be referred to as a distributed storage system for storing and hashing data. The network 104 may be a local area network (“LAN”), or may be a public network such as the Internet. Accordingly, any of the components in the system 100 may include communication ports configured to connect with a network. The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

### Workflows

As described above, the workflow generation may be visualizations using flowcharts. A flowchart definition language can define those workflows separate from the source code. Example visual workflows in the form of flowcharts are shown in FIGS. 2-12.

The flowchart definition language may define workflows separate from the source code. The workflows can be converted into machine code for execution. The workflows may be converted to machine code for execution by: 1) at compile time, the flowchart definition(s) are preprocessed into source code and then compiled, and/or 2) at run time, the flowchart definitions are interpreted by the running code.

Since the flowchart definitions and the flowchart definition language are separate from the implementation, there may not be a dependency on a specific programming language, language version, or tools. This also forces a separation of workflow logic. The flowchart definitions can be rendered into visual flowcharts (e.g., FIGS. 2-12) to enable non-subject-matter-experts to easily visualize the internal logic of the workflows.

The flowchart definition language may include but is not limited to commands such as:
call—call another flowchart and get the value that's returned from it;
get—get the value of a variable;
isMatch—test the value of a variable. The isMatch command may be paired with a matcher that describes how the variable comparison is done—for example StringEquals, NumericEquals, StringLike, etc.
next—set a variable to the next member of an iterative collection;
return—return a value from the flowchart;
set—set the value of a variable; and
then—determine the next flowchart node.

Each flowchart node may have a unique name. The then command identifies downstream flowchart nodes by this unique name. Variables may be prefixed with a predefined designator, such as a dollar sign $. Other values may be treated as constant values. Variables may have nested properties accessed with a dot (.), e.g., $request.httpmethod. There may be multiple levels of nesting.

In one example, inputs into the flowcharts may be obtained via a special variable named $PARAMS. The flowchart pre-compiler or interpreter may typically process $PARAMS value by generating/calling a function that fetches the required value and feeds it into the flowchart command.

FIG. 2 illustrates an example flowchartnode for a bucket policy. The flowchart preprocessor may generate this visual representation of the same node shown in FIG. 2. Workflows may be defined in structured formats including, but not limited to, YAML or JSON. For example, the example flowchart node for FIG. 2, in YAML, may be:
isBucketPolicyRequest:
   isMatch:
      $PARAMS.requestType: “s3: * BucketPolicy”
   matcher: StringLike
   then:
      true: isBPRequestBucketOwner
      false: checkACL

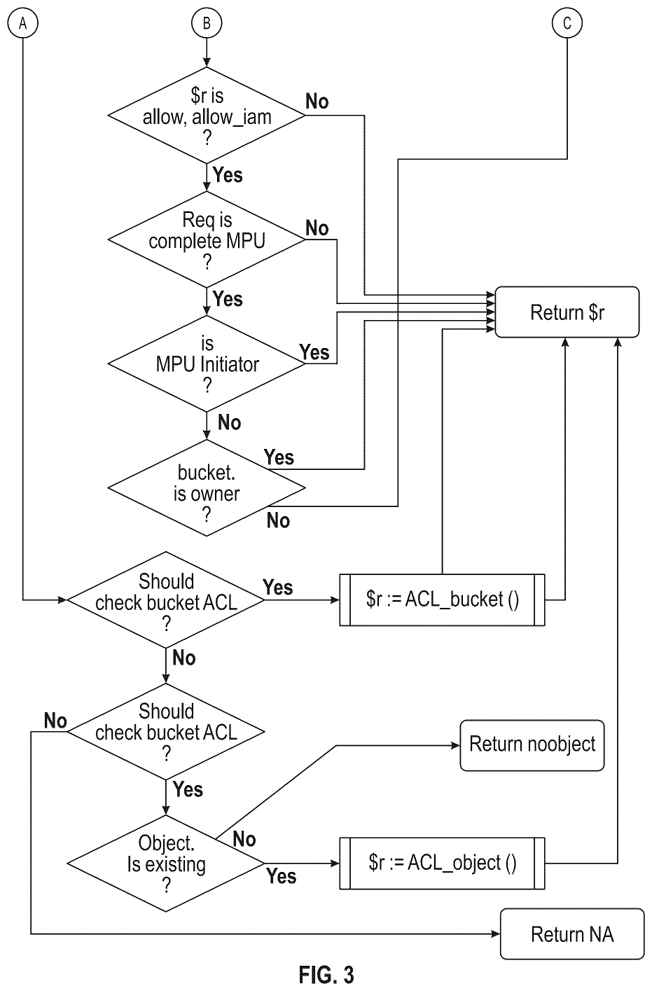

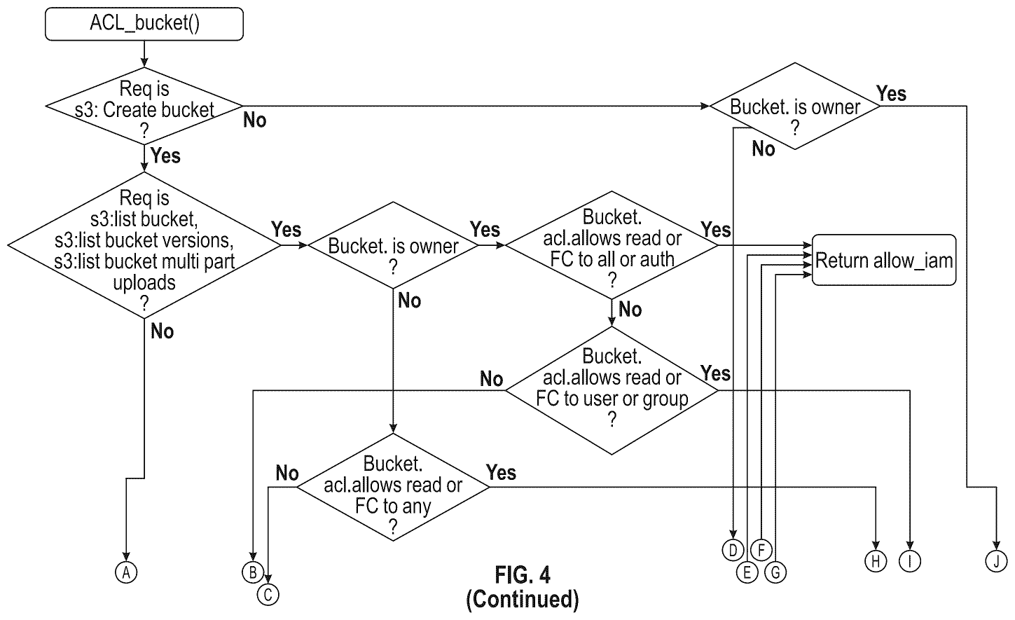

FIGS. 3-12 include more detailed examples of flowcharts that visualize workflows. As described above, workflows may be visualized through flowcharts using flowchart definitions and/or a flowchart definition language. The following Figures illustrate examples of those visualizations for different source code functions.

FIG. 3 illustrates an example flowchart for ACL.

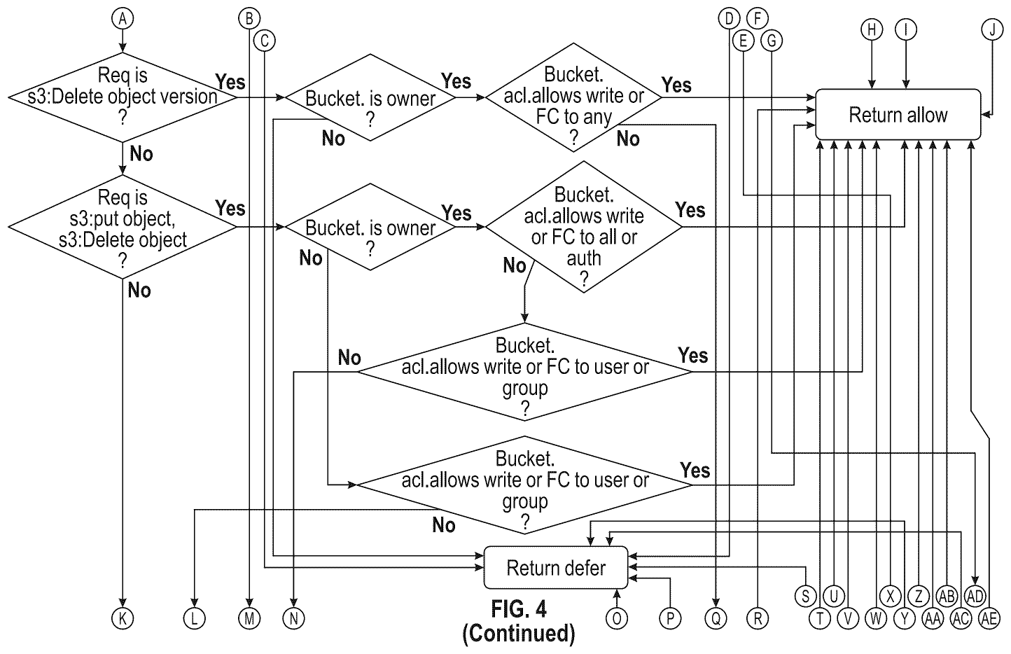

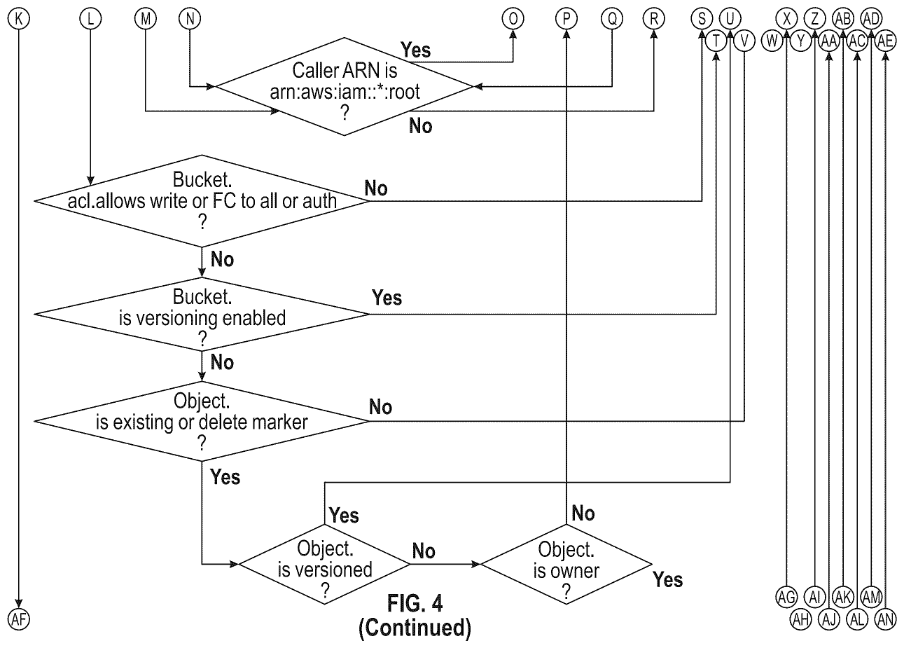

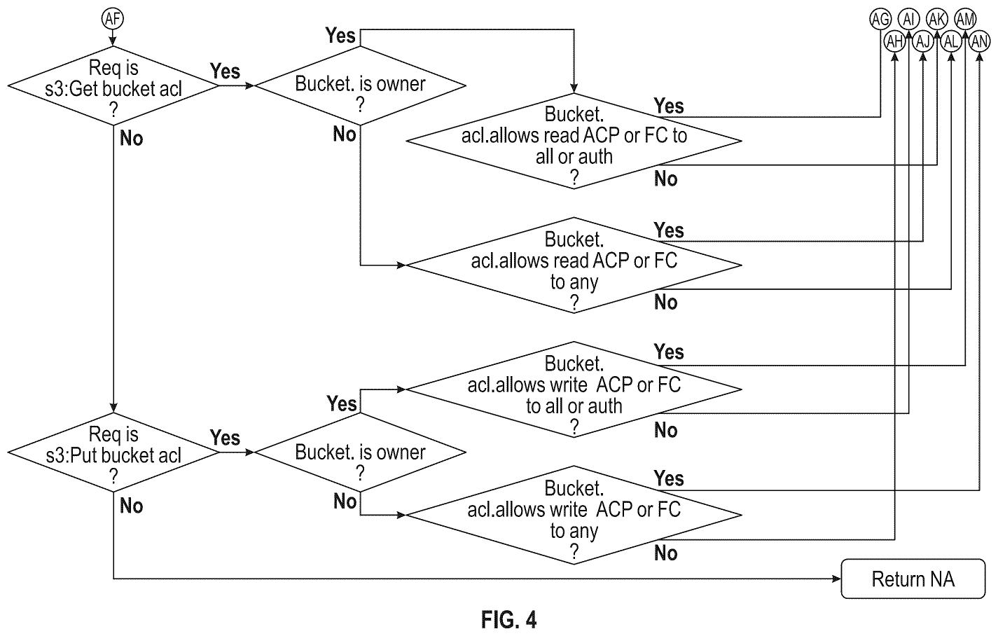

FIG. 4 illustrates an example flowchart for ACL bucket.

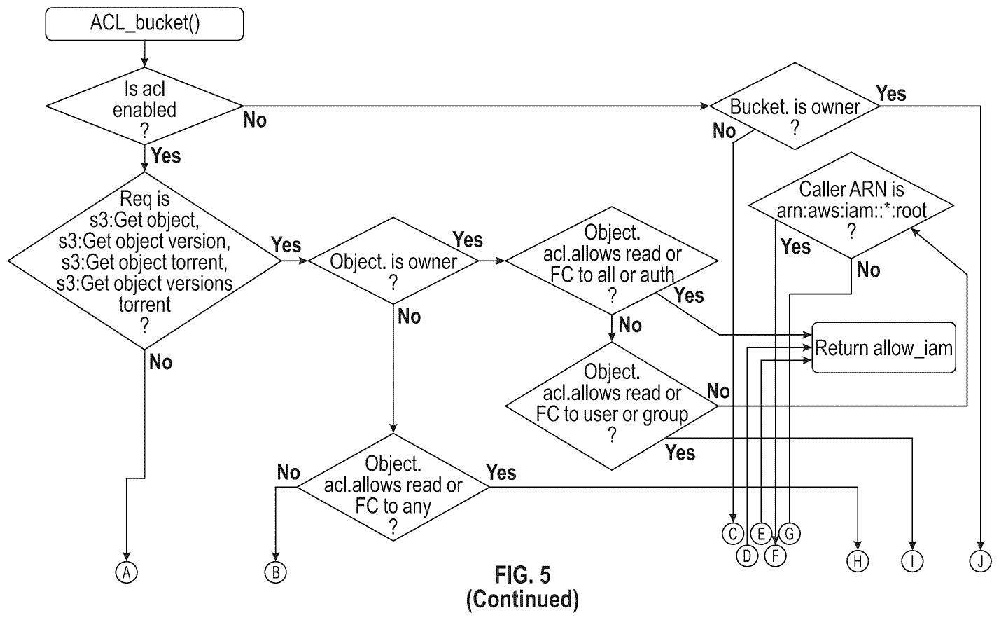

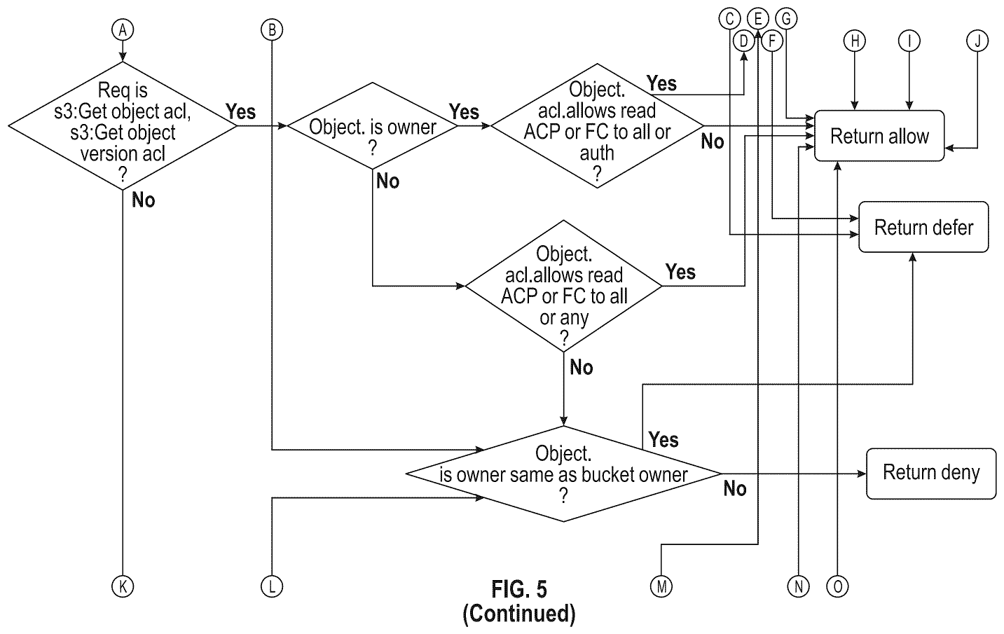

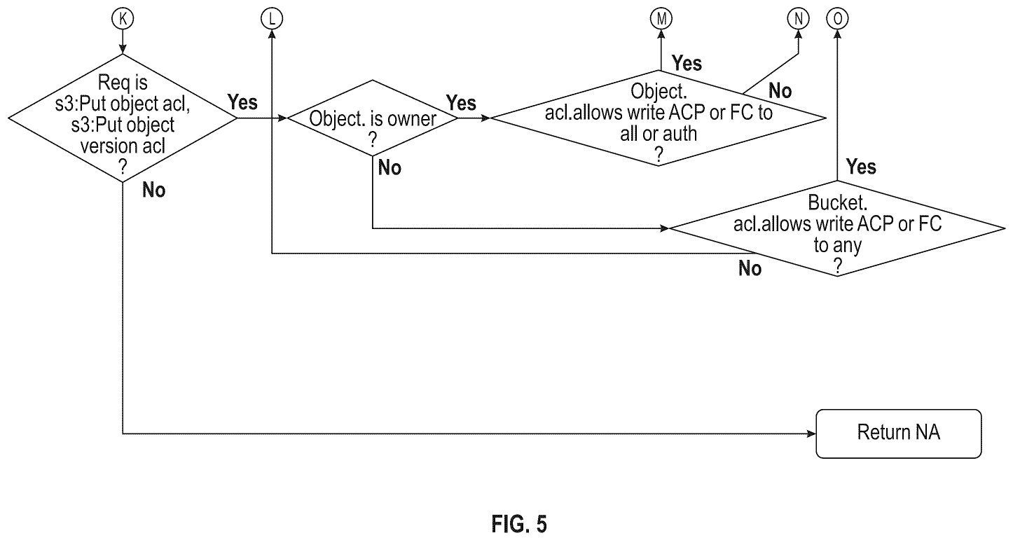

FIG. 5 illustrates an example flowchart for ACL object.

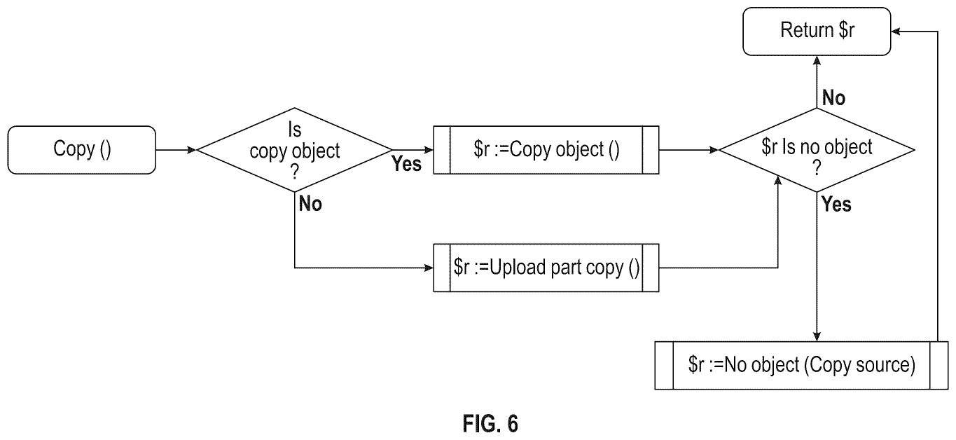

FIG. 6 illustrates an example flowchart for a copy operation.

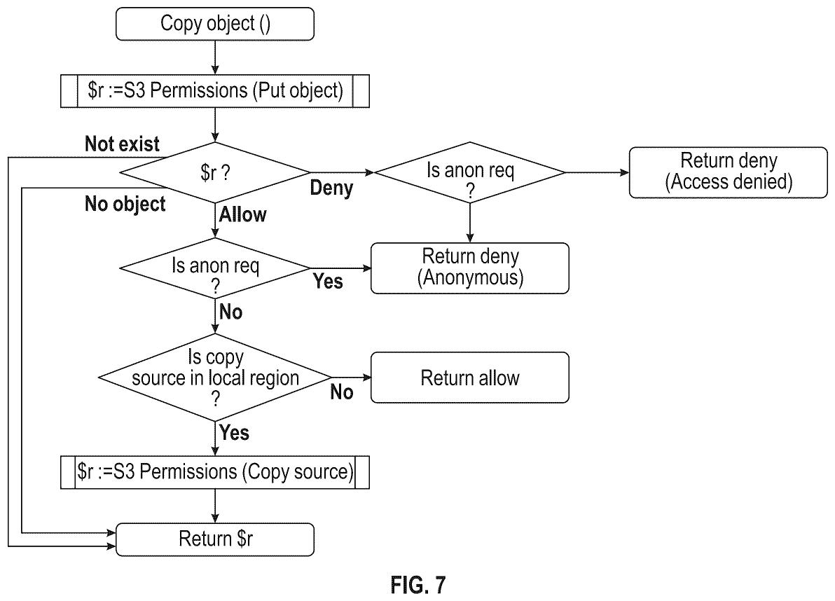

FIG. 7 illustrates an example flowchart for object copy.

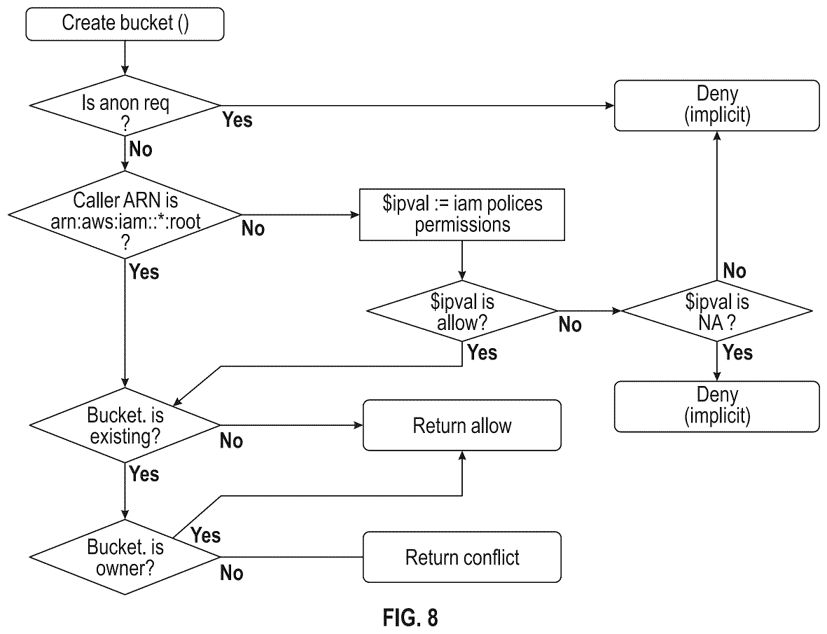

FIG. 8 illustrates an example flowchart for bucket creation.

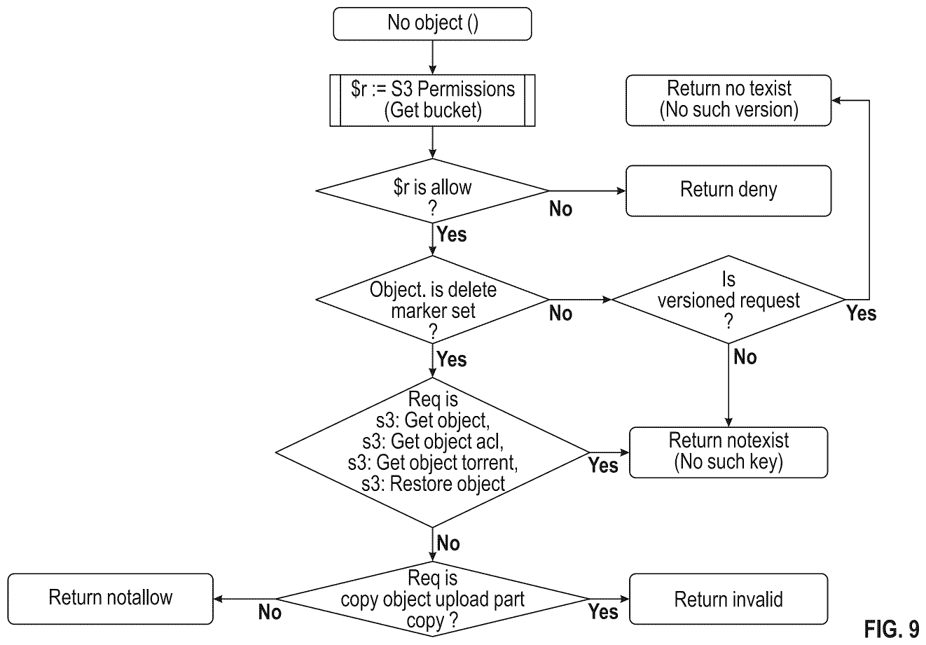

FIG. 9 illustrates an example flowchart for a no object operation.

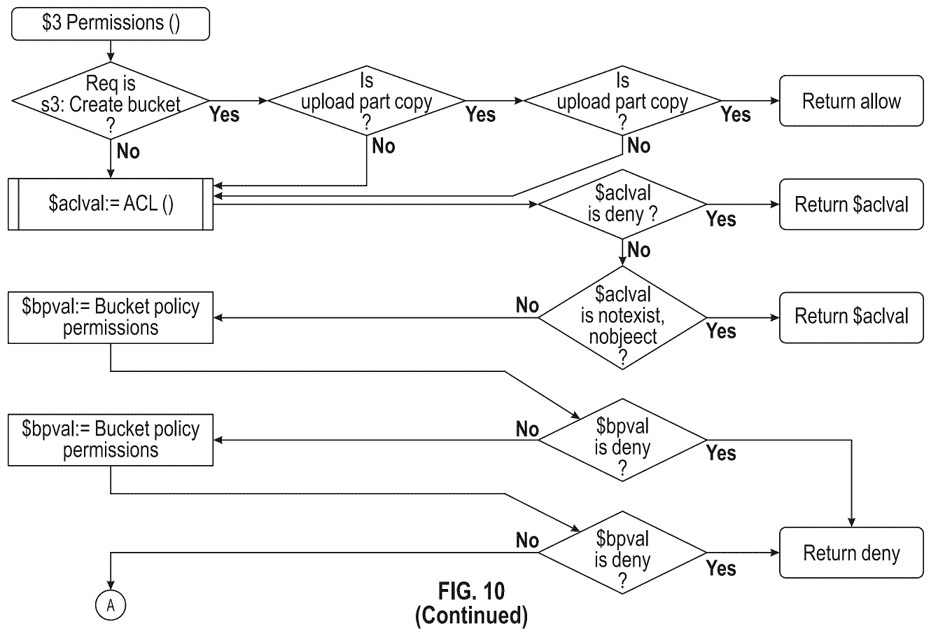

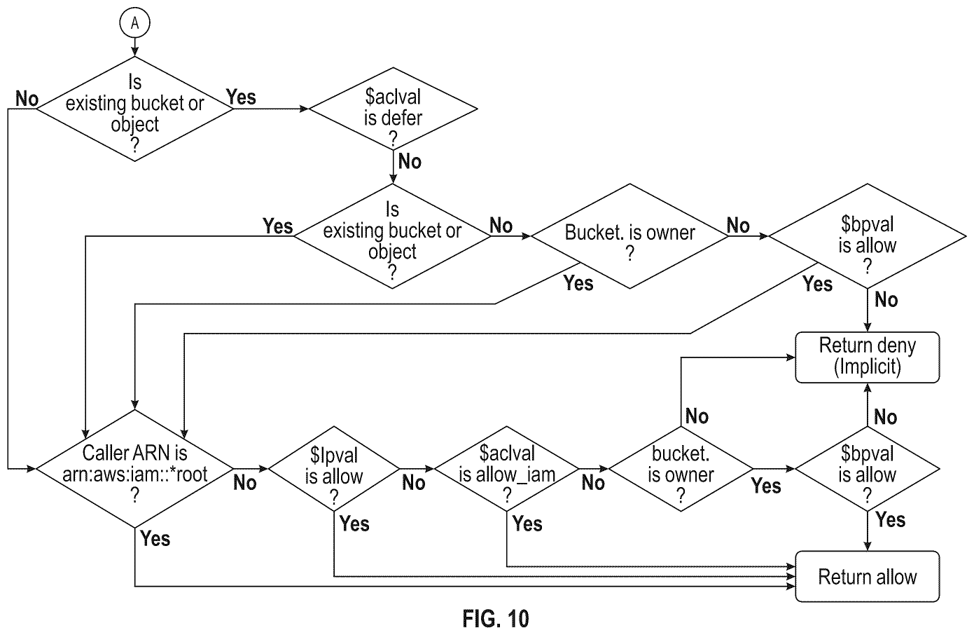

FIG. 10 illustrates an example flowchart for S3 permissions.

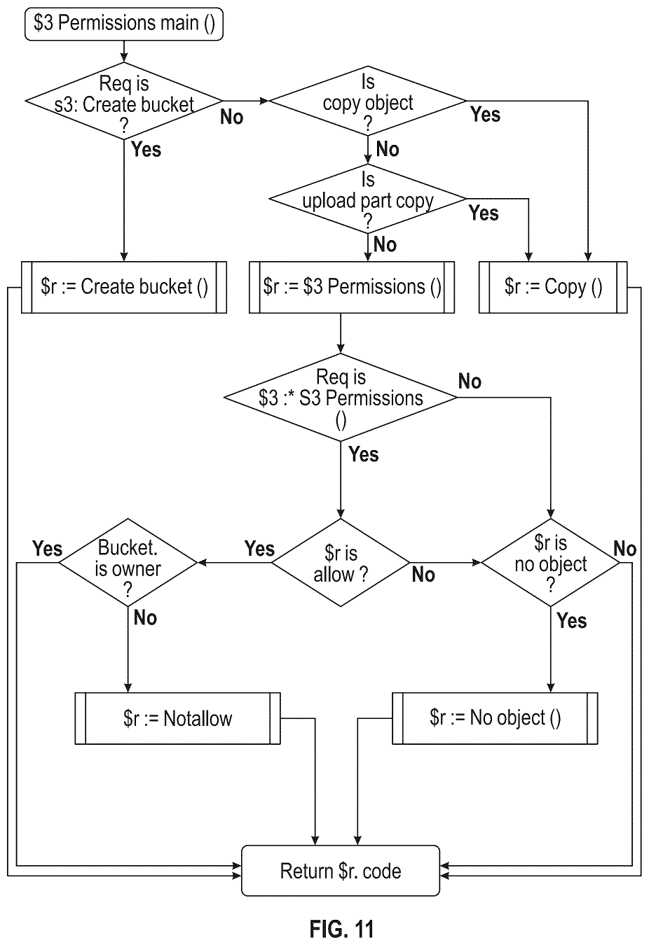

FIG. 11 illustrates an example flowchart for a main operation in S3 permissions.

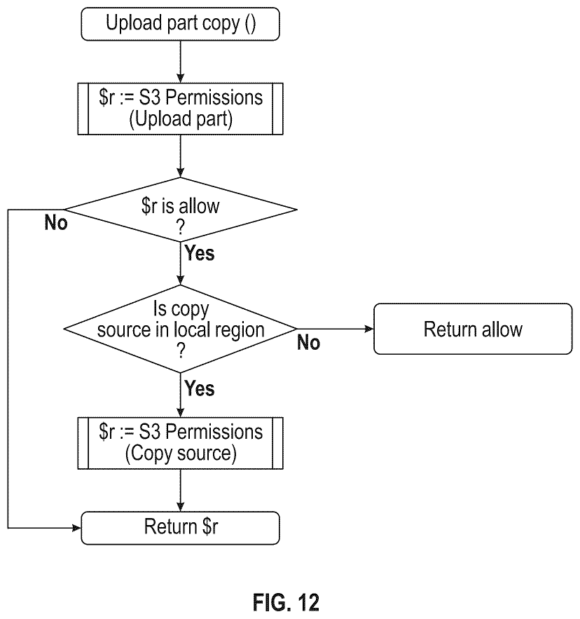

FIG. 12 illustrates an example flowchart for uploading part of a copy.

In particularly, FIG. 9 shows a flowchart, referred to as NoObject, that defines a workflow that may determine which error code to return if an object does not exist in an object storage system.

As shown in FIG. 9, the checkListBucketPerm node 902 demonstrates a use of a “call” command to call another flowchart, referred to as S3Permissions. It also demonstrates the use of the “with” directive to pass a new $PARAMS object into the called flowchart. In this case it is the original $PARAMS with the request type being replaced with “GetBucket”, but other values are also possible. It also demonstrates the use of the “set” command to assign the result returned from the “call” command to a variable, referred to as $r. In this case, assigning the result to a variable makes the result available throughout the remainder of the flowchart. It also demonstrates a use of the “then” command to unconditionally move to another node, e.g., the checkAllow node 904.

The example check Allow node demonstrates the use of the “isMatch” command with the “matcher” directive set to “StringEquals”. Arbitrary other “matcher” types may be defined, including but not limited to “StringLike”, “StringNotEquals”, “NumericEquals”, “NumericGreaterThan” and the like. In this case the “StringEquals” matcher may determine if the result from checkListBucketPerm 902 is exactly equal to the string “ALLOW”. It also demonstrates how the “then” command may automatically inspect the result of the “isMatch” command to conditionally determine which flowchart node to move to next. While the result of the “isMatch” command is boolean in this case, other types of results may also be returned by the “isMatch” command and tested by the “then” command, including but not limited to numerical types, string types, collections and objects.

The checkDeleteMarker node 906 demonstrates the use of the “get” command to read a value from the $PARAMS object. It also demonstrates how the “then” command may automatically inspect the value and conditionally determine which flowchart node to move to next. While the result of the “get” command is boolean in this case, other types may also be returned by the “get” command and tested by the “then” command, including but not limited to numerical types, string types, collections and objects.

The checkIsGetRequest node 908 demonstrates another form of the “isMatch” command that allows an input value to be matched against a collection of reference values.

The returnDENY node 910 demonstrates the use of the “return” command to return a value from the flowchart. The value may be returned to whichever flowchart originally called this one. While in this case the value is an object with two properties, “result” and “code”, it is also possible to return other types including (a) scalar values including but not limited to boolean, numeric and string values, (b) collections and (c) complex objects.

The flowchart definition also demonstrates how the “style” directive may be used to visually style the flowchart that is rendered from this definition. It may include attributes including but not limited to “label”, “color” and “fillcolor”, as shown by the visualized style of the various nodes in FIGS. 2-12.

The meaning of specific details should be construed as examples within the embodiments and are not exhaustive or limiting the invention to the precise forms disclosed within the examples. One skilled in the relevant art will recognize that the invention can also be practiced without one or more of the specific details or with other methods, implementations, modules, entities, datasets, etc. In other instances, well-known structures, computer-related functions or operations are not shown or described in detail, as they will be understood by those skilled in the art.

The discussion above is intended to provide a brief, general description of a suitable computing environment (which might be of different kinds like a client-server architecture or an Internet/browser network) in which the invention may be implemented. The invention will be described in the general context of computer-executable instructions, such as software modules, which might be executed in combination with hardware modules, being executed by different computers in the network environment. Generally, program modules or software modules include routines, programs, objects, classes, instances, components, data structures, etc., that perform particular tasks or implement particular abstract data types. Computer-executable instructions, associated data structures and program modules represent examples of the program code means for executing steps of the method described herein. The particular sequence of such executable instructions, method steps or associated data structures only represent examples of corresponding activities for implementing the functions described therein. It is also possible to execute the method iteratively.

Those skilled in the art will appreciate that the invention may be practiced in a network computing environment with many types of computer system configurations, including personal computers (PC), hand-held devices (for example, smartphones), multi-processor systems, microprocessor-based programmable consumer electronics, network PCs, minicomputers, mainframe computers, laptops and the like. Further, the invention may be practiced in distributed computing environments where computer-related tasks are performed by local or remote processing devices that are linked (either by hardwired links, wireless links or by a combination of hardwired or wireless links) through a communications network. In a distributed computing environment, program modules may be located in local or remote devices, memory systems, retrievals or data storages.

Generally, the method according to the invention may be executed on one single computer or on several computers that are linked over a network. The computers may be general purpose computing devices in the form of a conventional computer, including a processing unit, a system memory, and a system bus that couples various system components including system memory to the processing unit. The system bus may be any one of several types of bus structures including a memory bus or a memory controller, a peripheral bus and a local bus using any of a variety of bus architectures, possibly such which will be used in clinical/medical system environments. The system memory includes read-only memory (ROM) and random access memory (RAM). A basic input/output system (BIOS), containing the basic routines that have the functionality to transfer information between elements within the computer, such as during start-up, may be stored in one memory. Additionally, the computer may also include hard disc drives and other interfaces for user interaction. The drives and their associated computer-readable media provide non-volatile or volatile storage of computer executable instructions, data structures, program modules and related data items. A user interface may be a keyboard, a pointing device or other input devices (not shown in the figures), such as a microphone, a joystick or a mouse. Additionally, interfaces to other systems might be used. These and other input devices are often connected to the processing unit through a serial port interface coupled to the system bus. Other interfaces include a universal serial bus (USB). Moreover, a monitor or another display device is also connected to the computers of the system via an interface, such as a video adapter. In addition to the monitor, the computers typically include other peripheral output or input devices (not shown), such as speakers and printers or interfaces for data exchange. Local and remote computers are coupled to each other by logical and physical connections, which may include a server, a router, a network interface, a peer device or other common network nodes. The connections might be local area network connections (LAN) and wide area network connections (WAN) which could be used within the intranet or internet. Additionally, a networking environment typically includes a modem, a wireless link or any other means for establishing communications over the network.

Moreover, the network typically comprises means for data retrieval, particularly for accessing data storage means like repositories, etc. Network data exchange may be coupled by means of the use of proxies and other servers.

The example embodiments are to be considered in all respects only as illustrative and not restrictive. The scope of the invention is, therefore, indicated by the appended claims rather than by this description. All changes which come within the meaning and range of equivalency of the claims are to be embraced within their scope.

What is claimed is:

1. A method for workflow analysis of source code, the method comprising:
accessing a flowchart definition language separate from the source code; and
analyzing the source code with the flowchart definition language to generate workflows that include flowchart definitions from the flowchart definition language.

2. The method of claim 1, further comprising generating a visual representation of the workflows.

3. The method of claim 1, wherein the source code comprises permissions access on bucket policies.

4. The method of claim 3, wherein the permissions access are defined in the flowchart definition language.

5. The method of claim 3, wherein the generated workflows comprise a visualization of permissions.

6. A method for source code generation comprising:
utilizing a visualized workflow comprised of flowchart definitions; and
converting the visualized workflow into machine code for execution.

7. The method of claim 6, wherein the converting is at compile time, and includes preprocessing the flowchart definitions into source code and compiling the source code.

8. The method of claim 6, wherein the converting is at run time, and comprises interpreting the flowchart definitions at the run time.

9. The method of claim 6, wherein the visualized workflow comprises a visualization of permissions.
